(19) United States
(12) Patent Application Publication
(10) Pub. No.: US 2012/0019665 A1
(43) Pub. Date: Jan. 26, 2012

(54) AUTONOMOUS CAMERA TRACKING APPARATUS, SYSTEM AND METHOD

(76) Inventor: Jeffrey W. Toy, Irvington, KY (US)

(21) Appl. No.: 13/187,630

(22) Filed: Jul. 21, 2011

Related U.S. Application Data
(60) Provisional application No. 61/400,141, filed on Jul. 23, 2010.

(51) Int. Cl. H04N 5/225

(52) U.S. Cl. 348/169; 348/E05.024

(57) ABSTRACT

An autonomous camera tracking system. The system can include a tracking apparatus, and a beacon. The tracking apparatus can include an infrared sensor, a camera, a processor, and a panning stepper motor. The beacon can include an infrared emitter. The infrared sensor can receive an infrared signal from the beacon and, upon detection of a shift in the position of the infrared signal, the stepper motor can pan the camera and the infrared sensor so as to place the beacon in the field of view of the camera. The tracking apparatus can further include a tilting stepper motor, and, upon detection of a shift in the position of the infrared signal, the stepper motor can tilt the camera and the infrared sensor so as to place the beacon in the field of view of the camera.

### CROSS-REFERENCE TO RELATED APPLICATIONS

This application claims priority to U.S. Provisional Patent Application No. 61/400,141, filed Jul. 23, 2010 and entitled AUTONOMOUS CAMERA PAN SYSTEM, the entire contents of which are hereby incorporated by reference.

### BACKGROUND

Typically, cameras require an operator to keep the subject of the camera in the camera's field of view and in focus. When an operator is not available, the subject of the camera has a limited range of movement due to the necessity to remain in the camera's field of view and in focus. This can pose a problem in situations such as video conferencing and presentations recorded on video, where the presenter may need to move within a larger area. Such an area may be too large to remain within the field of view of a single, stationary camera.

Known subject tracking systems can suffer from several disadvantages. Typically equipment for tracking the subject of the camera is bulky, not easily transportable, and requires a studio or lab for operation. Such equipment may also not be fully autonomous, and may therefore require specialized training for operation of the system. Moreover, significant expenses can be involved with the purchase and operation of such systems.

A low-cost, portable, and easy-to-use autonomous camera tracking system is therefore desired.

### SUMMARY

According to at least one exemplary embodiment, an autonomous camera tracking system. The system can include a tracking apparatus, and a beacon. The tracking apparatus can include an infrared sensor, a camera, a processor, and a panning stepper motor. The beacon can include an infrared emitter. The infrared sensor can receive an infrared signal from the beacon and, upon detection of a shift in the position of the infrared signal, the stepper motor can pan the camera and the infrared sensor so as to place the beacon in the field of view of the camera. The tracking apparatus can further include a tilting stepper motor, and, upon detection of a shift in the position of the infrared signal, the stepper motor can tilt the camera and the infrared sensor so as to place the beacon in the field of view of the camera. The tracking apparatus can further include a pair of audio sensors, and, upon detection of a human voice by the pair of audio sensors, the stepper motor can move the camera so as to place the source of the human voice in the field of view of the camera.

According to another exemplary embodiment, a method for autonomous camera tracking may be disclosed. The method can include placing an infrared-emitting beacon on a subject, detecting the location of the beacon by an infrared sensor disposed coplanarly with a camera, detecting a movement of the beacon by the infrared sensor, and moving the camera and the infrared sensor so as to place the beacon within a field of view of the camera. The method can further include detecting a human voice by a pair of audio sensors, determining the location of the source of the human voice, and, moving the camera so as to place the source of the human voice within the field of view of the camera.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1a is a diagram of an exemplary embodiment of an autonomous camera tracking system.

FIG. 1b shows an exemplary embodiment of an autonomous camera tracking system in use.

FIGS. 2a-2e show another exemplary embodiment of an autonomous camera tracking system.

FIGS. 3a-3f show another exemplary embodiment of an autonomous camera tracking system.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

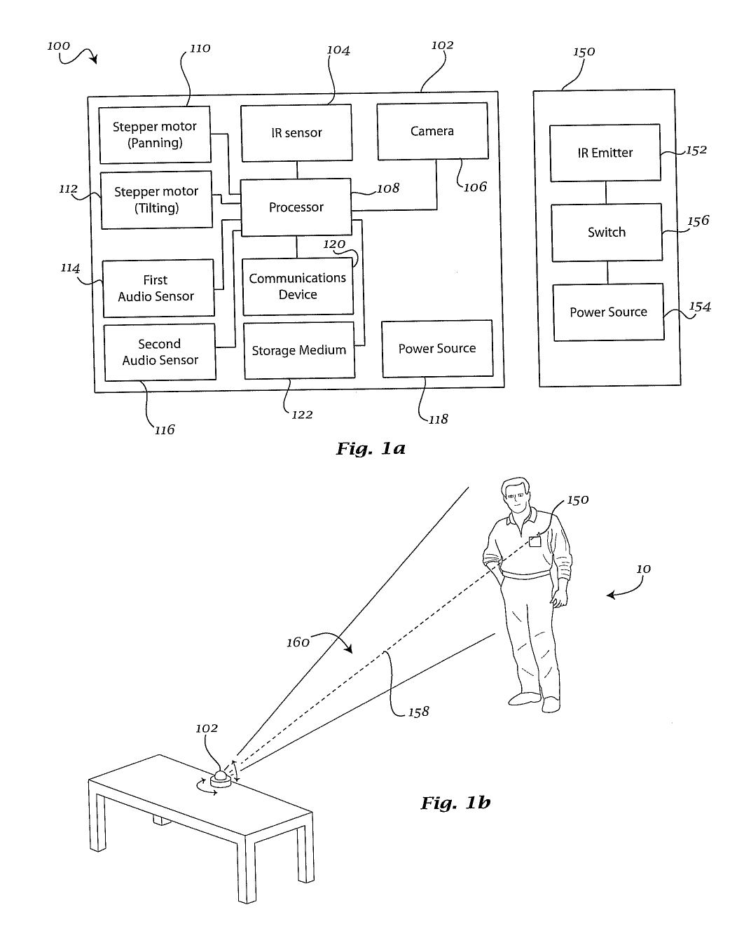

FIG. 1a shows an exemplary diagram of an autonomous camera tracking system 100. System 100 may include a tracking apparatus 102 and a beacon 150. Tracking apparatus 102 may include therein an infrared sensor 104, a camera 106, a processor 108, and a stepper motor 110 for panning camera 106 and IR sensor 104. Tracking apparatus 102 may further include a stepper motor 112 for tilting camera 106 and IR sensor 104. Additionally, tracking apparatus 102 may include two audio sensors 114, 116, a power source 118, a communications device 120 and a storage medium 122. Beacon 150 may include an infrared emitter 152, a switch 156 and a power source 154.

Camera 106 may be any camera known in the art, for example a digital CCD sensor or CMOS sensor. Camera 106 may be communicatively coupled to processor 108, which may in turn be communicatively coupled to IR sensor 104 and stepper motors 110, 112.

Turning to FIG. 1b, an exemplary embodiment of autonomous camera tracking system 100 is shown in operation. A person 10 may attach beacon 150 to the person's body or clothing. Upon activation of tracking apparatus 102 and beacon 150, IR emitter 152 of beacon 150 may emit an infrared beam 158 towards tracking apparatus 102. Infrared beam 158 may be received by IR sensor 104.

As person 10 moves around an area, IR sensor 104 may detect a shift in the source of the infrared beam 158. Processor 108 may then determine the horizontal angular displacement and the vertical angular displacement of IR sensor 104 that is necessary such that IR beam 158 is normal to the plane of IR sensor 104. Processor 108 may then activate stepper motors 110, 112 to achieve the desired vertical and horizontal angular displacements. As camera 106 and IR sensor 104 may be disposed in the same plane and in substantially the same location, the panning and tilting of IR sensor 104 and camera 106 can result in person 10 being in the field of view 160 of camera 106 when IR beam 158 is normal to the plane of IR sensor 104.

Returning to FIG. 1a, tracking apparatus 102 may include audio sensors 114, 116, which may be positioned on opposite sides of the housing of tracking apparatus 102. Audio sensors 114, 116 may be adapted to pick up audio frequencies in the range of typical human voice frequencies. Processor 108 may receive inputs from audio sensors 114, 116, and may use such inputs to determine the vertical and angular displacement of camera 106 so as to place the source of the voice in the field of view of camera 106. This may be achieved by comparing the strength of the signals from sensor 114 and sensor 116. Camera 106 and sensors 114, 116 may then be tilted and panned in the direction of the stronger signal until the signals from both sensors 114, 116 are substantially equal. The audio sensor may be used for subject tracking in situations having multiple subjects, rather than a single subject. Such situations may include conferences, where a number of people are present, for example, around a table, and where it is desirable to track any person who is speaking, rather than a single person.

Video captured by camera 106 may be stored on storage medium 122, which may be any digital storage medium known in the art, for example flash memory, random-access memory, or a magnetic disk. Video captured by camera 106 may also be output via communications device 120, which may be a wired communications device such as an Ethernet, USB, FireWire, or Thunderbolt controller and port, or which may be a wireless communications device such as a Bluetooth or 802.11 compliant device. Video may be output live as it is captured or may be stored on storage medium 122 and subsequently output via communications device 120.

Stepper motors 110, 112 may be powered by direct current, and therefore power source 118 may be a DC power source such as any known battery, which may be rechargeable. Power source 118 may also include a connection to an alternating current power source and can then include an AC to DC converter.

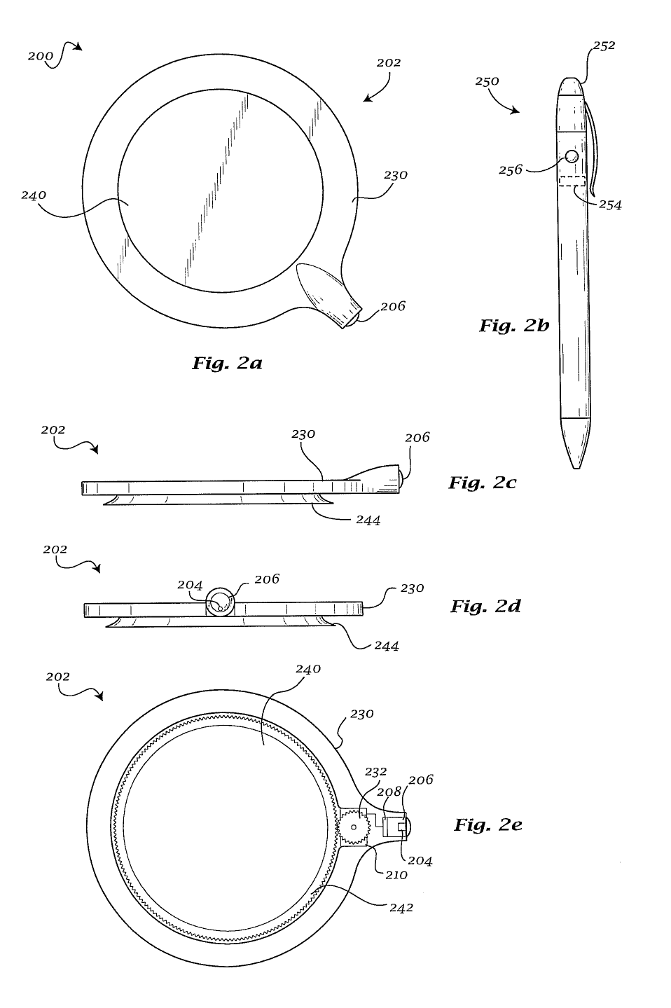

FIGS. 2a-2e show another exemplary embodiment of an autonomous camera tracking system 200. System 200 may include a tracking apparatus 202 and a beacon 250. Beacon 250 may include an IR emitter 252, switch 256 and power source 254. Beacon 250 may have any desired shape. For example, beacon 250 may be shaped as a pen, and may include components for writing therein.

Tracking apparatus 202 may include a camera housing 230, which can include therein camera 206 and IR sensor 204. Camera housing 230 may be substantially planar and have an annular shape. A geared cylinder 240 may have a substantially planar and circular shape and may be sized to fit within the central aperture of annular camera housing 230. Geared cylinder 240 may include a toothed ring 242 disposed around the circumference thereof. Geared cylinder 240 may further be coupled to a pedestal 244, which may be placed upon any desired surface.

Camera housing 230 may include therein an IR sensor 204, a camera 206, processor 208, and any other desired components, such as a power source, storage medium, and a communications device. Camera housing 230 may further include therein a panning stepper motor 210 which may be coupled to a gear 232. Gear 232 may be rotatably mounted within housing 230, with the axis of rotation of gear 232 being normal to the plane of geared cylinder 240. The teeth of gear 232 may engage the teeth of toothed ring 242. Thus, as the IR sensor 204 detects a shift in the angle of incidence of an IR beam emitted by IR emitter 252 of beacon 250, processor 208 may direct stepper motor 210 to rotate gear 232, thereby rotating camera housing 230 around geared cylinder 240, which can remain stationary. As camera housing 230 only includes panning capabilities, the housing may be rotated until the vertical plane of the IR beam is normal to the plane of the IR sensor, while the displacement of the beam from the horizontal plane not being taken into consideration.

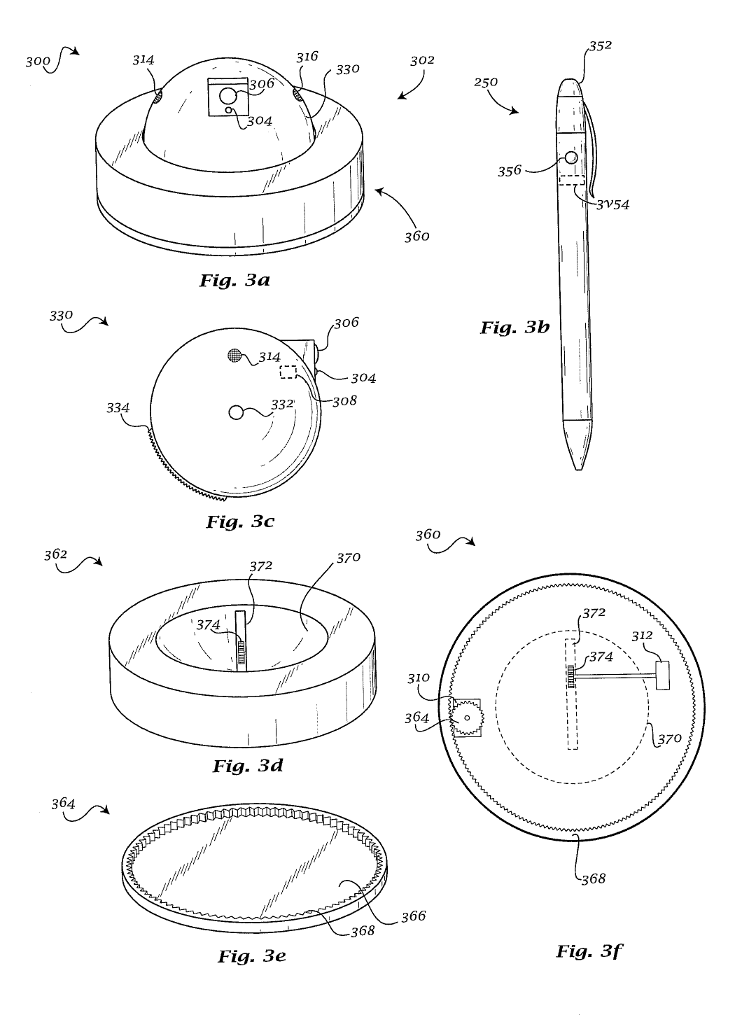

FIGS. 3a-3f show another exemplary embodiment of an autonomous camera tracking system 300. System 300 may include a tracking apparatus 302 and a beacon 350. Beacon 350 may include an IR emitter 352, switch 356 and power source 354. Beacon 350 may have any desired shape. For example, beacon 350 may be shaped as a pen, and may include components for writing therein.

Tracking apparatus 302 may include a camera housing 330 and a pedestal 360. Camera housing 330 may be substantially spherical and can include therein camera 306, IR sensor 304 and processor 308, as well as audio sensors 314, 316, which may be disposed at chordally opposed points on camera housing 330. Camera housing 330 may further include any other desired components, such as a power source, storage medium, and a communications device.

Pedestal 360 may include a top portion 362 and a bottom portion 364. Bottom portion 364 may include a bottom surface 366 and a toothed ring 368 extending vertically from bottom surface 366. Toothed ring 368 may be substantially annular and may include a plurality of teeth disposed on the inner circumference thereof. Bottom portion 364 can be placed on any desired surface.

Top portion 362 may include a substantially hemispherical concavity 370 defined in the top surface thereof. Hemispherical concavity 370 may be sized to receive camera housing 330 therein. Housing 330 may be tiltably mounted within concavity 370 by diametrically opposed rods 332 which may be received within slots defined in the surface of hemispherical concavity 370. Communication couplings between the components disposed within camera housing 330 and pedestal 360 may be routed through rods 332 and the corresponding slots. Housing 330 may further include a toothed strip 334 disposed substantially diametrically opposite the location of camera 306.

Top portion 362 may include therein a panning stepper motor 310 which may be coupled to a gear 364. Gear 364 may be rotatably mounted within top portion 362, with the axis of rotation of gear 364 being normal to the plane of toothed ring 368. The teeth of gear 364 may engage the teeth of toothed ring 368. Thus, as the IR sensor 304 detects a shift in the angle of incidence of an IR beam emitted by IR emitter 352 of beacon 350, processor 308 may direct stepper motor 310 to rotate gear 364, thereby rotating top portion 362 and camera housing 330 around geared cylinder 240, which can remain stationary. Alternatively, the rotation of top portion 362 may be directed by processor 308 in response to signals received from audio sensors 314, 316, substantially as described above.

Hemispherical concavity 370 can include a slit 372, which may be sized and shaped to receive toothed strip 334 of camera housing 330. A tilting stepper motor 312 may be coupled to a gear 374. Gear 374 may be rotatably mounted within top portion 362 with the axis of rotation of gear 374 being perpendicular to the axis of rotation of gear 372. Gear 374 may further be positioned such that gear 374 may engage the teeth of toothed strip 334. Thus, as the IR sensor 304 detects a shift in the angle of incidence of an IR beam emitted by IR emitter 352 of beacon 350, processor 308 may direct stepper motor 312 to rotate gear 374, thereby tilting camera housing 330.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. An autonomous camera tracking system, comprising:
a tracking apparatus, the tracking apparatus comprising an infrared sensor, a camera, a processor, and a panning stepper motor; and
a beacon, the beacon comprising an infrared emitter;
wherein the infrared sensor receives an infrared signal from the beacon; and
wherein, upon detection of a shift in the position of the infrared signal, the panning stepper motor pans the camera and the infrared sensor so as to place the beacon in the field of view of the camera.

2. The autonomous camera tracking system of claim 1, wherein:
the tracking apparatus further comprises a tilting stepper motor; and
wherein, upon detection of a shift in the position of the infrared signal, the tilting stepper motor tilts the camera and the infrared sensor so as to place the beacon in the field of view of the camera.

3. The autonomous camera tracking system of claim 1 or claim 2, wherein:
the tracking apparatus further comprises a pair of audio sensors; and
wherein, upon detection of a human voice by the pair of audio sensors, the panning stepper motor pans the camera so as to place the source of the human voice in the field of view of the camera.

4. The autonomous camera tracking system of claim 1, wherein the tracking apparatus further comprises one or more of:
a power source;
a storage medium; and
a communications device.

5. The autonomous camera tracking system of claim 1, wherein the beacon further comprises one or more of:
a power source; and
a switch.

6. The autonomous camera tracking system of claim 1, wherein the tracking apparatus further comprises:
a camera housing, the camera housing including the infrared sensor, the camera, and the panning stepper motor;
a geared cylinder having a toothed ring disposed on the outer circumference thereof;
a gear, disposed within the camera housing, coupled to the panning stepper motor and engaging the toothed ring of the geared cylinder;
wherein the panning stepper motor turns the gear so as to rotate the camera housing with respect to the geared cylinder.

7. The autonomous camera tracking system of claim 3, wherein the tracking apparatus further comprises:
a camera housing, the camera housing including the infrared sensor, the camera, a pair of audio sensors;
a pedestal including a top portion and a bottom portion;
the bottom portion of the pedestal including a bottom surface and a toothed ring extending vertically from the bottom surface, the toothed ring having a plurality of teeth on the inner circumference thereof;
the top portion of the pedestal adapted to pivotably mount the camera housing therein, and including the panning stepper motor and the tilting stepper motor; and
a gear, disposed within the top portion of the pedestal, coupled to the panning stepper motor and engaging the toothed ring of the bottom portion of the pedestal;
wherein the panning stepper motor turns the gear so as to rotate the camera housing with respect to the geared cylinder; and
wherein the tilting stepper motor tilts the camera housing with respect to the pedestal.

8. The autonomous camera tracking system of claim 7, wherein:
the camera housing further comprises a toothed strip disposed on the surface thereof; and
the top portion of the pedestal further comprises a slit for receiving the toothed ring, and a gear, disposed within the top portion, coupled to the tilting motor stepper motor and engaging the toothed strip of the camera housing.

9. A method for autonomous camera tracking, comprising:
placing an infrared-emitting beacon on a subject;
detecting the location of the beacon by an infrared sensor disposed coplanarly with a camera;
detecting a movement of the beacon by the infrared sensor; and
moving the camera and the infrared sensor so as to place the beacon within a field of view of the camera.

10. The method of claim 9, further comprising:
detecting a human voice by a pair of audio sensors;
determining the location of the source of the human voice; and
moving the camera so as to place the source of the human voice within the field of view of the camera.
